(19) United States
(12) Patent Application Publication
(10) Pub. No.: US 2007/0120757 A1
(43) Pub. Date: May 31, 2007

(54) Rod antenna mounted at rear window of vehicle

(76) Inventors: Kazushige Ogino, Kobe-shi (JP); Yoshio Umezawa, Kobe-shi (JP); Koji Nagao, Kobe-shi (JP); Kazuo Takayama, Kobe-shi (JP)

Correspondence Address: CHRISTIE, PARKER & HALE, LLP, PO BOX 7068, PASADENA, CA, 91109-7068, US

(21) Appl. No.: 11/606,755

(22) Filed: Nov. 29, 2006

(30) Foreign Application Priority Data
Nov. 30, 2005 (JP) 2005-346778

(51) Int. Cl. H01Q 1/32; H01Q 1/02

(52) U.S. Cl. 343/713; 343/704

(57) ABSTRACT

A rod antenna with a good reception sensitivity using a conductive body of a vehicle or a heater element of a defogger as a reflector, that is, a rod antenna to be mounted at a conductive outside surface of a vehicle or at an outside surface of a rear window of a vehicle where heater elements of a defogger are arranged in parallel, provided with a rod-shaped antenna element provided with a predetermined length and a holding member comprised of a base member for holding the antenna element and an antenna support member, the holding member holding the antenna element so that it is separated a predetermined distance from the outside surface so that the outside surface becomes a reflector for the antenna element.

### CROSS-REFERENCE TO RELATED APPLICATION

This application claims priority from, and incorporates by reference, the entire disclosure of Japanese Patent Application No. 2005-346778 filed on Nov. 30, 2005.

### BACKGROUND OF THE INVENTION

1. Field of the Invention

The present invention relates to a rod antenna, a method of mounting a rod antenna to a rear window of a vehicle, and a receiver using a rod antenna, more particularly relates to a rod antenna mounted at a conductive outside surface of a vehicle or a rear window of a vehicle provided with heater elements for a defogger, a method of mounting a rod antenna at the rear window of a vehicle, and a receiver using a rod antenna.

2. Description of the Related Art

Since the past, automobiles and other vehicles (moving bodies) have been equipped with antennas able to receive electromagnetic waves even during motion. The electromagnetic waves received by vehicles have for many years mainly been medium waves (MW) for AM radio use and very high frequency (VHF) or ultrahigh frequency (UHF) for FM radio use or television use. In recent years, GPS (global positioning system) antennas, antennas for receiving terrestrial digital broadcasts, and other antennas for sending and receiving high frequency band electromagnetic waves have become necessary in vehicles. Further, antennas for sending and receiving electromagnetic waves to and from beacons of electronic toll systems (ETC) and vehicle information communication systems (VICS) have become necessary in vehicles.

The location where an antenna is mounted when mounting an antenna on a moving body such as an automobile is generally the front window or rear window of the vehicle. When an antenna is mounted at the front window, the antenna is formed on a transparent film and this transparent film-like antenna is adhered to the inside of the front window of the automobile.

The adhesion of such a transparent film-like antenna at the front window of an automobile is described in for example Japanese Patent Publication (A) No. 2005-102183. The antenna described in this publication is an integrated antenna comprised of a transparent film formed with a GPS antenna, satellite digital broadcasting antenna, ETC antenna, TV broadcasting antenna, etc., that is, comprised of a film on which a plurality of antenna elements are formed by conductive ink, conductive foil, etc.

On the other hand, when an antenna is mounted on the rear window, the antenna is mostly placed at the rear window or the rear body at the rear of the vehicle. As the antenna in this case, a rod antenna (pole antenna) sticking out in a direction away from the chassis is generally used. This reason is that the rear body of a vehicle is made of metal. The rear window is provided with a defogger comprised of heater elements (electrical heating wires for defogging), so these end up having an effect on the electromagnetic waves. This makes mounting a sheet-like antenna there difficult.

However, a rod antenna sticking out to the rear from the rear body of a vehicle or the part of the chassis where the rear window is set ruins the appearance and therefore is not preferable design wise. Further, even if trying to set a film antenna at the rear window, it ends up being affected by the heater elements of the defogger. In particular, digital TV broadcasts are horizontally polarized waves. The heater elements of the defogger are arranged in the horizontal direction, so the defogger blocks the electromagnetic waves of the digital TV broadcasts. A film antenna adhered to the inside of the passenger compartment therefore has difficulty receiving the electromagnetic waves of digital TV broadcasts.

### SUMMARY OF THE INVENTION

An object of the present invention is therefore to provide a rod antenna not sticking out that much from the rear from the vehicle body and having a good reception sensitivity even if mounted at a conductive body or rear window of a vehicle, a method of mounting a rod antenna at the rear window of a vehicle, and a receiver using a rod antenna.

To achieve this object, according to a first aspect of the present invention, there is provided a rod antenna to be mounted at a conductive outside surface of a vehicle or at an outside surface of a rear window of the vehicle where heater elements of a defogger are arranged in parallel, provided with a rod-shaped antenna element provided with a predetermined length and a holding member holding the antenna element, the holding member holding the antenna element so that it is separated a predetermined distance from the outside surface so that the outside surface becomes a reflector for the antenna element in the state.

In this aspect of the invention, the holding member can be comprised of a base member fixed to the outside surface of the vehicle and an antenna support member sticking out from this base member. Further, the holding member can be configured so that the antenna element is held parallel to the outside surface. Further, the antenna element can be configured to have a length of approximately ¼ of the wavelength of the received frequency, while the holding member can be configured to have a distance from the outside surface to the antenna element of a length of approximately 1/7.5 of the receiving wavelength of the antenna.

In this aspect, if the predetermined distance of the antenna element from the outside surface is 7 to 11 cm, preferably 8 cm, the rod antenna becomes suitable for digital television broadcasts. Further, if the predetermined length of the antenna element is 10.5 cm to 16 cm, preferably 15 cm, the rod antenna becomes preferable for digital television broadcasts.

Further, to achieve the above object, according to a second aspect of the invention, there is provided a method of mounting a rod antenna of the present invention on a rear window of a vehicle comprising placing a holding member in a region between an electrode part of a defogger provided at the rear window or a folded part of a heater element of a defogger and mounting frame of the rear window on the vehicle, holding an antenna element by the holding member so as to become parallel to a heater element of the defogger, and using the heater element as a reflector for the antenna element.

Further, to achieve the object, according to a third aspect of the present invention, there is provided a receiver using a rod antenna for receiving digital broadcasts in an automobile, provided with loop antennas mounted at either side of the top of a front window of the vehicle and having directionality to the forward of the front window, rod antennas mounted at either side of the top of the rear window of the vehicle and having directionality to the backward of the rear window, and a receiver to which the two loop antennas and two rod antennas are connected, the receiver selecting and outputting the electromagnetic wave for which the sensitivity is best among the electromagnetic waves received by the two loop antennas and two rod antennas.

In this case, the loop antennas may be made film antennas comprised of film shaped sheets on which antenna elements are formed and the rod antennas may be made rod antennas of the above aspect of the invention.

As explained above, according to the rod antenna and method of mounting a rod antenna on a rear window of the present invention, the antenna can be mounted in parallel to a conductive body of the vehicle or a heater element of the defogger provided at the rear window without sticking out much from the rear of the body of the vehicle. By using a conductive body of the vehicle or a heater element of the defogger as a reflector, it is possible to provide a rod antenna with a good reception sensitivity and a method of mounting this antenna at the rear window of a vehicle.

### BRIEF DESCRIPTION OF THE DRAWINGS

The present invention will be more clearly understood from the description as set forth below with reference to the accompanying drawings, wherein:

FIG. 1 is a perspective view of a sedan type automobile provided with antennas according to an embodiment of the present invention at the rear window,

FIG. 2 is perspective view of the configuration of an antenna of FIG. 1,

FIG. 3 is a back view of a vehicle showing the locations of mounting the antennas shown in FIG. 2 at the back door of a hatchback type vehicle;

FIG. 4 is a cross-sectional view showing the state of mounting an antenna of FIG. 3 on the rear window;

FIG. 5 is a cross-sectional view showing the state of mounting an antenna shown in FIG. 3 at a metal part of the back door;

FIG. 6 is a block circuit diagram showing the connection of the two antennas of FIG. 1 to a navigation system;

FIG. 7 is a perspective view of a sedan type automobile provided with rod antennas of an embodiment of the present invention at the rear window, provided with film antennas at the front window, and provided with a television receiver and car navigation system; and

FIG. 8 is a block circuit diagram showing the connection of the four antennas of FIG. 7 to a navigation system.

### DESCRIPTION OF THE PREFERRED EMBODIMENTS

Below, the attached drawings will be used to explain in detail embodiments of a rod antenna and the method of mounting a rod antenna at the rear window of a vehicle of the present invention based on specific embodiments.

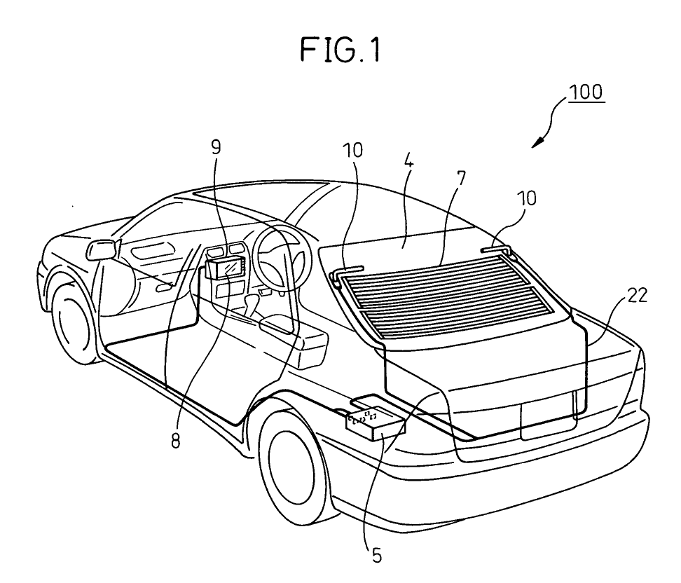

FIG. 1 shows a sedan type automobile 100 provided with antennas 10 according to an embodiment of the present invention at a rear window 4. The rear window 4 of the automobile 100 is provided with a defogger 7. The defogger 7 is comprised of electrodes provided at the two sides of the rear window 4 and heater elements bridging the same. The heater elements are arranged so as to be aligned in the horizontal direction when seen from the rear of the automobile 100. Further, there are also defoggers 7 where electrodes are not provided at the two sides of the rear window 4 but the heater elements are turned around at the two ends.

The antennas 10, in this embodiment, are provided at the outside surface of the rear window 4 of the automobile 100 between the electrodes of the defogger 7 and the mounting frame of the rear window 4 and, for example, receive terrestrial digital television broadcasts. The antennas 10 have coaxial cables 22 connected to it. These coaxial cables 22 are connected to a TV tuner 5 set below the rear seats of the automobile 100. The signals received by the TV tuner 5 (audio and video) are input to a car navigation system 8 provided at the instrument panel 9 by the coaxial cables 22 and is displayed by the car navigation system 8 on a display at the television mode.

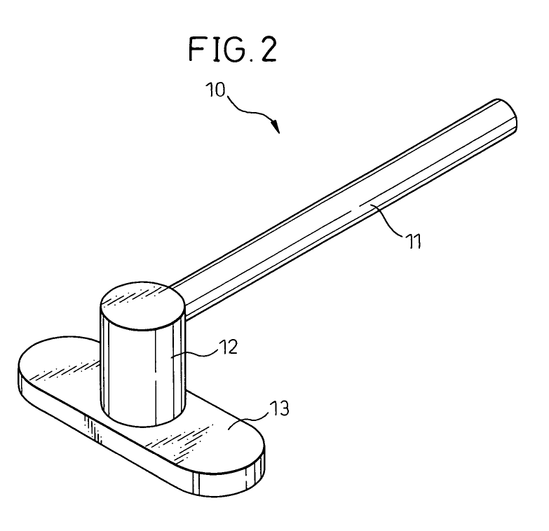

The two antennas 10 are comprised so that the antenna elements become parallel to the outside surface when mounted on the outside surface of the automobile. Details of these antennas 10 are shown in FIG. 2. Each antenna 10 is comprised of a rod-shaped antenna element 11 provided with a predetermined length and a holding member holding this antenna element 11. The holding member in this embodiment is comprised of a base member 13 fastened to the outside surface of the automobile 100 and an antenna support member 12 sticking out from this base member 13. The antenna support member 12 can be configured to rotate with respect to the base member 13. Further, the antenna support member 12 supports the antenna element 11 in parallel with respect to the mounting surface of the base member 13 on the outside surface of the automobile.

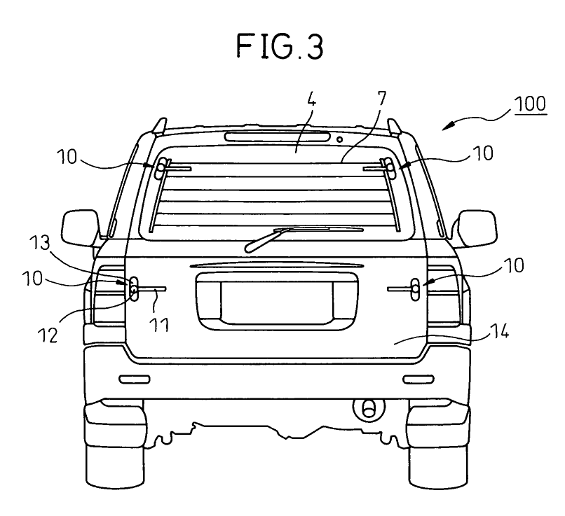

FIG. 3 shows an example of the locations where the antennas 10 shown in FIG. 2 are mounted in the case of a back door 14 of a hatchback type vehicle 100. First, the method of mounting the antennas 10 at the rear window 4 provided at the back door 14 will be explained.

When mounting each antenna according to an embodiment of the present invention 10 at the rear window 4, the base member 13 explained in FIG. 2 is mounted at the outside surface between the electrode of the defogger 7 provided at the rear window 4 of the automobile 100 and the frame for mounting the rear window 4 to the chassis. It can be mounted by a binder coated on the bottom of the base member 13. Next, the antenna support member 12 is rotated with respect to the base member 13 and the antenna element 11 of the antenna 10 is made parallel to a heater element of the defogger 7. The antenna 10 is mounted on the rear window 4 by the above procedure.

On the other hand, each antenna 10 shown in FIG. 2 can be mounted at a metal part of the back door 14 of a hatchback type vehicle 100 other than the rear window 4. When mounting the antenna 10 of this example at the back door 14, if the base member 13 explained in FIG. 2 is set so that the antenna element 11 becomes parallel to the outside surface, the antenna 10 can be mounted at any part of the outside surface of the back door 14 of the automobile 100.

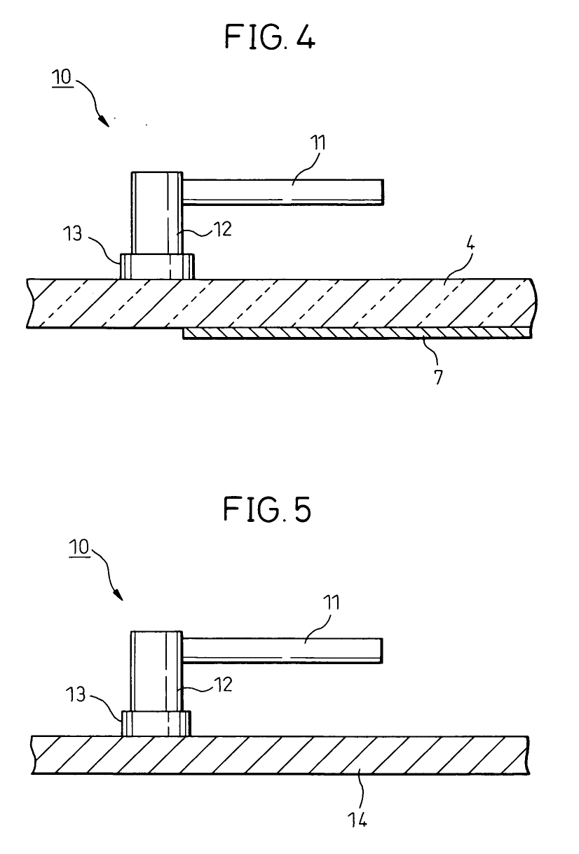

FIG. 4 shows the state with an antenna 10 shown in FIG. 3 mounted at the rear window 4. The base member 13 is fastened near the defogger 7 provided at the rear window 4 of the automobile 100, while the antenna 11 is supported by the antenna support member 12 sticking out from the base member 13. In this case, the antenna element 11 of the antenna 10 is substantially parallel to a heater element of the defogger 7. The heater element of the defogger 7 becomes a reflector for the antenna element 11 of the antenna 10.

FIG. 5 shows the state where an antenna 10 shown in FIG. 3 is mounted to a metal part of the back door 14. The base member 13 is fixed to a metal part of the back door 14 of the automobile 100. The antenna element 11 is supported at the antenna support member 12 projecting from the base member 13. In this case, the antenna element 11 of the antenna 10 becomes substantially parallel to the metal part of the back door 14 of the automobile 100. The metal part of the back door 14 serves as a reflector for the antenna 11 of the antenna 10.

In the above embodiment, the antenna element 11 is preferably comprised to have a length of ¼of the wavelength of the received frequency of the antenna 10. Further, when the antenna 10 has a received frequency in a predetermined bandwidth, considering the center frequency of that bandwidth or the density of the broadcast wave or the characteristics of the antenna, it is comprised to have a length of ¼ of the wavelength of a predetermined frequency able to be received well at the band as a whole.

Further, each antenna 10 of the present invention is preferably comprised so that the base member 13 and antenna support member of the holding member make the distance from the heater element of the defogger 7 to the antenna element 11 and the distance from the metal part of the back door 14 to the antenna element 11 become lengths of 1/7.5 of the wavelength of the received frequency of the antenna 10. Further, when the received frequency of the antenna 10 has a predetermined bandwidth, it preferably is comprised to have a length of 1/7.5 of the wavelength of the center frequency of the bandwidth.

In the case of digital television broadcasts, there are many broadcast waves at the low end of the frequency band 470 to 770 MHz and the antenna characteristics gradually attenuate above the center frequency rather than lower it, therefore, an antenna preferably is given a center frequency of 500 MHz as confirmed by the assignee from experiments etc. Due to this, ¼ of the wavelength 64 cm to 39 cm for the frequency band 470 to 770 MHz, that is, 10.5 to 16 cm, is preferable as the length of the antenna element. In particular, ¼ of the wavelength for the frequency 500 MHz, that is, 15 cm, is more preferable as the length of the antenna element.

Further, the distance of the antenna element from a metal part, while depending on the material or structure of the metal part etc., is preferably 1/5.5 to 1/8.5 of the wavelength 64 cm to 39 cm for the frequency band 470 to 770 MHz, that is, 4.5 to 11.6 cm, more preferably 1/5.5 to 1/8.5 of the wavelength 60 cm for the frequency 500 MHz, that is, 7 to 11 cm, still more preferably 1/7.5 of the wavelength 60 cm, that is, 8 cm, as confirmed by the assignee from experiments etc.

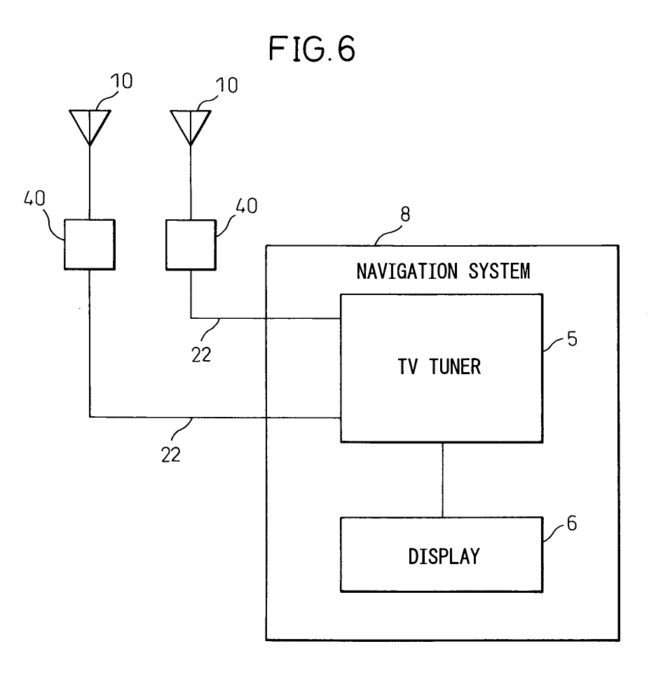

FIG. 6 is a block circuit diagram showing the connection of the two antennas 10 of FIG. 1 to a navigation system 8. In the example shown in FIG. 1, the TV tuner 5 was separate from the navigation system 8, but in this example, the TV tuner 5 is built into the navigation system 8. When the antennas 10 are antennas receiving terrestrial digital television waves, the signals received by the antennas 10 are guided through integrated circuits 40, built into the holding members of the antennas 10 and amplifying the signals, by cables 22 to the television tuner 5, then the demodulated image is displayed by the navigation system 8 on the display 6 at the time of a television mode.

Note that this embodiment shows only the case where the antennas 10 are connected to the TV tuner 5 built into the navigation system 8. The rest of the configuration of the navigation system 8 is not illustrated or explained. This is because both when the antennas 10 are antennas for GPS and antennas for satellite digital broadcasts, the circuits up to the receiver are not that different from the circuit of this embodiment.

When the thus configured rod antennas 10 are mounted on the rear window 4 or back door 19 of the automobile 100, the heater elements of the defogger 7 or the metal parts of the back door act as reflectors, whereby the rod antennas 10 can efficiently receive electromagnetic waves arriving from the rear of the automobile. That is, the rod antennas 10 of the present invention mounted on the rear window 4 or backdoor 19 of the automobile 100 have directionality with respect to the rear of the automobile.

As opposed to this, when mounting loop antennas formed on film sheets above the front window of an automobile, the loop antennas can be given directionality with respect to the front of the automobile.

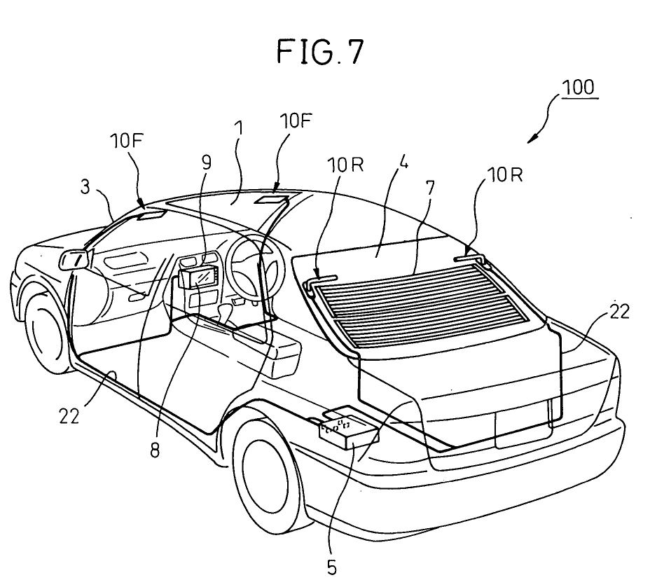

Therefore, in the present invention, as shown in FIG. 7, there is provided an automobile 100 provided with rod antennas 10 of any of the above explained embodiments at the rear window 4 with a defogger 7 or at metal parts of a back door 19 and provided with a TV tuner 5 and car navigation system 8, wherein loop antennas 10F formed on sheet-like films are mounted at either side of the top of the front window 1. Note that in this embodiment, the rod antennas 10 mounted at the rear window 4 or metal parts of the back door 19 are shown as the “rod antennas 10R”.

Two power feed terminals of the loop antennas 10F are connected through not shown connectors to coaxial cables 22. The coaxial cables 22 are led along A pillars 3 of the automobile and connected to the TV tuner 5. The loop antennas 10F can receive terrestrial digital television broadcasts. Further, the signals (audio and video) received by the TV tuner 5 are input to the car navigation system 8 provided at the instrument panel 9 by a coaxial cable 22. The car navigation system 8 displays the received image on the display at the time of the television mode.

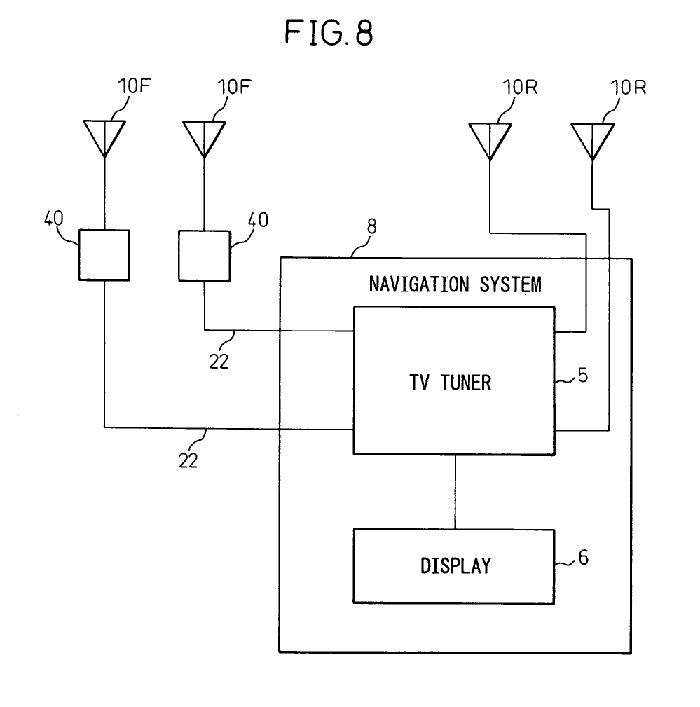

FIG. 8 is a block circuit diagram showing the connection of the two rod antennas 10R and two loop antennas 10F of FIG. 7 to the navigation system 8. In the example shown in FIG. 7, the TV tuner 5 was separated from the navigation system 8, but in this example, the TV tuner 5 is built into the navigation system 8. When the rod antennas 10R and the loop antennas 10F are antennas receiving terrestrial digital television waves, the signals received by the rod antennas 10R are led through the integrated circuits 40, built into the base members 13 and amplifying the signals etc., by the cables 22 to the television tuner 5, while the signals received by the loop antennas 10F are led through the integrated circuits 40, built into the connectors and amplifying the signals etc., by the cables 22 to the digital TV tuner 5.

The digital TV tuner 5 selects and demodulates the signal with the highest field strength among the input signals of the four antennas 10F,10R. Further, the demodulated image is displayed on the display 6 by the navigation system 8 in the television mode.

As a result, with an omnidirectional antenna like with a conventional car-mounted antenna, when receiving a terrestrial digital television wave, the reception distribution deteriorates and the transmission and reception performance drops at the time of high speed operation of the automobile due to the multipath effect, but with a receiver of the present invention provided with four antennas, when receiving terrestrial digital television waves, the TV tuner 5 selects and demodulates the signal with the highest field strength among the received signals, so it is possible to secure stable transmission and reception performance even during high speed operation of the automobile.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A rod antenna to be mounted at a conductive outside surface of a vehicle or at an outside surface of a rear window of a vehicle where heater elements of a defogger are arranged in parallel, provided with
a rod-shaped antenna element provided with a predetermined length and
a holding member holding said antenna element,
said holding member holding said antenna element so that it is separated a predetermined distance from said outside surface so that said outside surface becomes a reflector for said antenna element.

2. A rod antenna as set forth in claim 1, wherein said holding member is comprised of a base member fixed to said outside surface of the vehicle and an antenna support member sticking out from this base member.

3. A rod antenna as set forth in claim 1, wherein said holding member is configured so that said antenna element is held parallel to said outside surface.

4. A rod antenna as set forth in claim 1, wherein said antenna element is configured to have a length of approximately ¼ of a wavelength of a received frequency.

5. A rod antenna as set forth in claim 1, wherein said holding member is configured to have a distance from said outside surface to said antenna element of a length of approximately 1/7.5 of the receiving wavelength of said antenna.

6. A rod antenna as set forth in claim 1, wherein
said predetermined distance is 7 to 11 cm, and
said rod antenna is for digital television broadcasts.

7. A rod antenna as set forth in claim 1, wherein
said predetermined distance is 8 cm, and
said rod antenna is for digital television broadcasts.

8. A rod antenna as set forth in claim 1, wherein
said predetermined length is 10.5 cm to 16 cm, and
said rod antenna is for digital television broadcasts.

9. A rod antenna as set forth in claim 1, wherein
said predetermined length is 15 cm, and
said rod antenna is for digital television broadcasts.

10. A method of mounting on a rear window of a vehicle a rod antenna provided with a rod-shaped antenna element provided with a predetermined length and a holding member holding said antenna element, said holding member holding said antenna element so that it is separated a predetermined distance from said outside surface so that said outside surface becomes a reflector for said antenna element, to be mounted at a conductive outside surface of a vehicle or at an outside surface of a rear window of a vehicle where heater elements of a defogger are arranged in parallel,
said method of mounting a rod antenna on a rear window comprising:
placing a holding member in a region between an electrode part of a defogger provided at said rear window or a folded part of a heater element of a defogger and mounting frame of said rear window on the vehicle,
holding an antenna element by said holding member so as to become parallel to a heater element of said defogger, and
using said heater element as a reflector for said antenna element.

11. A receiver using rod antennas for receiving terrestrial digital broadcasts in an automobile, provided with
loop antennas mounted at either side of the top of a front window of the vehicle and having directionality to the forward of said front window,
rod antennas mounted at either side of the top of said rear window of the vehicle and having directionality to the backward of said rear window, and
a receiver to which said two loop antennas and two rod antennas are connected,
said receiver selecting and outputting the electromagnetic wave for which the sensitivity is best among the electromagnetic waves received by said two loop antennas and two rod antennas.

12. A receiver using antennas as set forth in claim 11, wherein
said loop antennas are film antennas comprised of film-shaped sheets on which antenna elements are formed and
said rod antennas are rod antennas as set forth in any one of claims 1 to 9.
